(19) United States
(12) Patent Application Publication
(10) Pub. No.: US 2008/0074335 A1
(43) Pub. Date: Mar. 27, 2008

(54) BUILT-IN ANTENNA FOR PORTABLE TERMINAL

(75) Inventor: Young-Hoon SUH, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/860,978

(22) Filed: Sep. 25, 2007

(30) Foreign Application Priority Data
Sep. 25, 2006 (KR) 2006-0092715

(51) Int. Cl. H01Q 1/22; H01Q 9/04

(52) U.S. Cl. 343/702; 343/700 MS

(57) ABSTRACT

Provided is a built-in antenna for a portable terminal. The built-in antenna includes a main board including a feed pad electrically connected to a Radio Frequency (RF) connector, and a ground layer with a predetermined area; an antenna carrier installed on the main board and having a predetermined height; an antenna radiator installed at the antenna carrier and having a predetermined shape, the antenna radiator being electrically connected to the feed pad; and a conductor installed at a predetermined portion of the antenna carrier, the conductor being electrically connected to the ground layer.

### PRIORITY

This application claims priority under 35 U.S.C. §119(a) to an application filed in the Korean Intellectual Property Office on Sep. 25, 2006 and allocated Serial No. 2006-92715, the contents of which are incorporated herein by reference.

### BACKGROUND OF THE INVENTION

1. Field of the Invention

The present invention relates generally to a built-in antenna module embedded in a portable wireless terminal, and in particular, to a built-in antenna module for a portable wireless terminal configured to improve a radiation characteristic of a Planar Inverted-F Antenna (PIFA), and antenna performance such as reducing the Specific Absorption Rate (SAR).

2. Description of the Related Art

Recently, terminals with various functions and designs are being introduced. Consumers' demands for smaller, lighter and slimmer terminals with various functions are increasing. To meet such consumers' demands, terminal providers are focused on reducing the volume of a terminal while maintaining or improving functions thereof.

An antenna, a rod antenna (or a whip antenna), and a helical antenna that protrude outwardly from a terminal are susceptible to damage from dropping, and reduce portability of the terminal. Therefore, a plate-type built-in antenna (i.e., “internal antenna” or “intenna”) installed inside a terminal is widely used, and various efforts are made to improve a characteristic of the built-in antenna and also improve productivity and assemblability thereof.

FIG. 1 is a perspective view of a general slide type portable terminal 100. However, the type of terminal is not limited to the slide type, and a variety of terminals with built-in antennas can be used. Examples of the terminals, which have various designs and open/close types, may include a folder type terminal, a bar type terminal, and a flip type terminal.

As illustrated in FIG. 1, the general portable terminal 100 includes a main body 110, and a slide body 120 that can slide a predetermined distance longitudinally over the main body 110. A display unit 121 is installed on a front surface of the slide body 120. A speaker unit 123 that can receive and output a voice of another party is installed on the display unit 121, and at least one keypad assembly 122 is installed under the display unit 121. The keypad assembly 122 includes a navigation key button so that a user can use basic functions of the terminal without opening the slide body 120.

Another keypad assembly 111 may be installed on a surface of the main body 110 viewed when the slide body 120 is opened on the main body 110. As the keypad assembly 111, number key buttons (3×4 key buttons) may be installed. A microphone unit 112 that can input and transmit a voice of a user to another party is installed under the keypad assembly 111.

FIG. 2 is a rear perspective view of the terminal of FIG. 1, showing an installation location of a conventional built-in antenna in the terminal, and a portion that affects deterioration of antenna performance when a user touches the portion with a finger for grasping the terminal (hereinafter, a “finger touch portion”).

Referring to FIG. 2, a battery pack 113, i.e., a power supply unit of the terminal 100, is detachably installed at a rear surface of the terminal. The built-in antenna is installed in a terminal case frame placed above the installed battery pack 113. The antenna may be installed in a width direction of the terminal. In detail, the antenna may be mounted directly on the main board 110 of the terminal 100 by a Surface Mounted device (SMD) method, or may be mounted using an antenna carrier having a predetermined height. In FIG. 2, a dotted line indicated by arrow A indicates the installation location of the built-in antenna.

Examples of a radiator used in the built-in antenna may include a Planar Inverted-F Antenna (PIFA) radiator and a Planar Inverted-L Antenna (PILA) radiator.

In the PIFA radiator, two points, i.e., a feed point and a ground point, are electrically connected to a main board of a main body. Here, the ground point is connected to a ground layer of the main body. In comparison, in the PILA radiator, only a feed point of a radiator is electrically connected to a feed pad of a main board.

The PIFA radiator may have a small size because it is implemented to have a length of λ/4. Also, the PIFA radiator is less affected by an external effect (e.g., a finger touch occurring when a user grasps the terminal) because of its electrical connection to a ground unit of the main board. However, since feeding and grounding must be simultaneously performed, it is difficult to match an impedance, which makes it difficult to achieve maximum performance of the radiator.

In contrast, in the case of the PILA radiator, it is relatively easy to achieve maximum antenna performance, since the PILA radiator is a monopole type in which only the feed point is electrically connected to the main board. However, the PILA is mounted to a terminal, and is susceptible to an external effect such as a user's finger touch. Thus, fluctuation of Voltage Standing Wave Ratio (VSWR) of the antenna radiator is increased, which causes a mute phenomenon, and lowers a radiation characteristic of the antenna.

### SUMMARY OF THE INVENTION

An object of the present invention is to substantially solve at least the above problems and/or disadvantages and to provide at least the advantages below. Accordingly, an object of the present invention is to provide a built-in antenna for a portable terminal configured to prevent deterioration of antenna performance caused by external interference.

Another object of the present invention is to provide a built-in antenna for a portable terminal configured to achieve maximum antenna performance by installing a conductor at a built-in antenna and thus reducing fluctuation of VSWR caused by external interference.

Still another object of the present invention is to provide a built-in antenna for a portable terminal configured to facilitate impedance matching for coupling and to prevent deterioration of a radiation characteristic caused by external interference.

According to one aspect of the present invention, a built-in antenna for a portable terminal includes a main board including a feed pad electrically connected to a Radio Frequency (RF) connector, and a ground layer with a predetermined area; an antenna carrier installed on the main board and having a predetermined height; an antenna radiator installed at the antenna carrier and having a predetermined shape, the antenna radiator being electrically connected to the feed pad; and a conductor installed at a predetermined portion of the antenna carrier separately from the antenna radiator, the conductor being electrically connected to the ground layer.

### BRIEF DESCRIPTION OF THE DRAWINGS

The above and other objects, features and advantages of the present invention will become more apparent from the following detailed description when taken in conjunction with the accompanying drawings in which:

FIG. 1 is a front perspective view of a general portable terminal including a built-in antenna;

FIG. 2 is a view showing an installation location of a conventional built-in antenna of a general terminal, and a finger touch portion deteriorating antenna performance;

FIG. 3 is an exploded perspective view of a built-in antenna according to the present invention;

FIG. 4 is a rear perspective view illustrating a mounted state of an antenna radiator according to the present invention;

FIG. 5 is an assembled perspective view of an antenna according to the present invention;

FIG. 6 is a cross-sectional view of a main part, illustrating a ground structure of a conductor of an antenna according to the present invention;

FIG. 7 is a rear perspective view of a carrier, illustrating that a conductor is installed on a different location of the carrier from that of FIG. 3 according to the present invention;

FIG. 8 illustrates a Smith chart and a VSWR graph, showing states before and after a finger-touch on a terminal including a conventional antenna radiator; and

FIG. 9 illustrates a Smith chart and a VSWR graph, showing states before and after a finger-touch on a terminal including an antenna radiator according to the present invention.

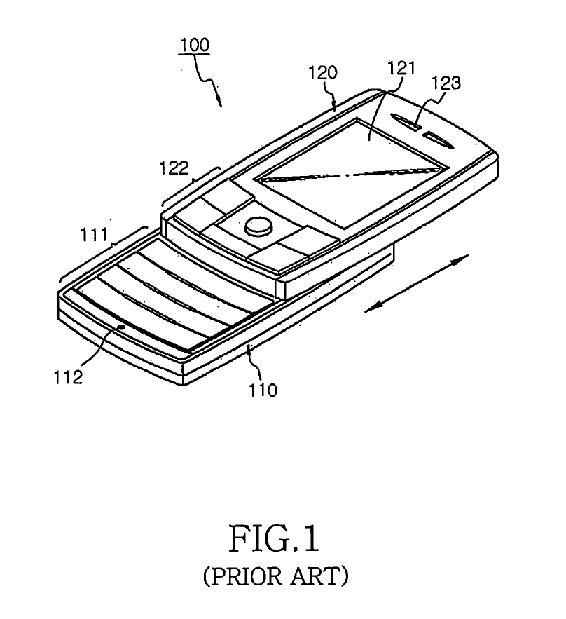

### DETAILED DESCRIPTION OF THE PREFERRED EMBODIMENTS

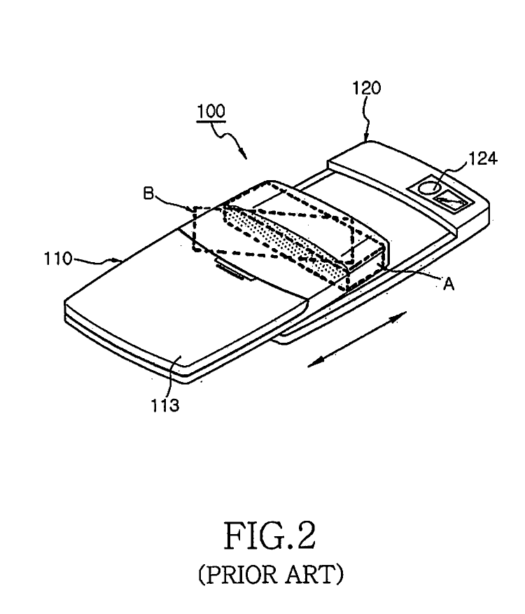

Preferred embodiments of the present invention will be described herein below with reference to the accompanying drawings. In the following description, well-known functions or constructions are not described in detail since they would obscure the invention in unnecessary detail. Since a built-in antenna according to the present invention is also applied to part A of FIG. 2, the description thereof will be omitted.

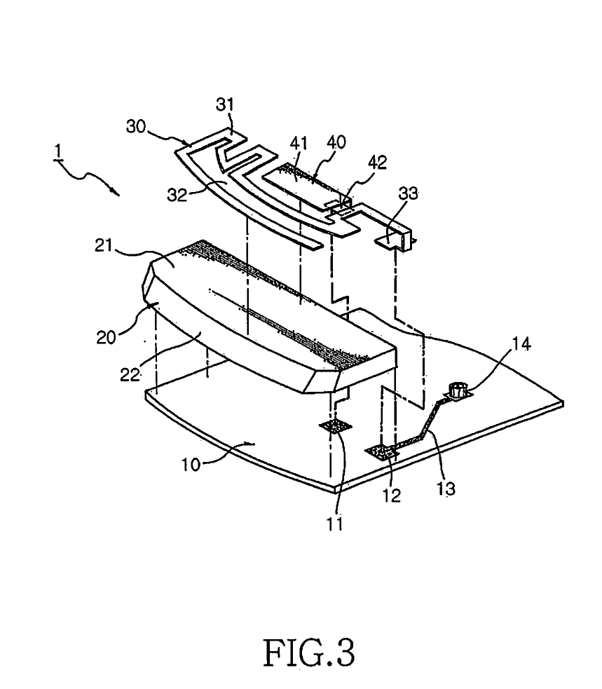

FIG. 3 is an exploded perspective view of a built-in antenna 1 according to the present invention. The built-in antenna 1 includes a main board 10 which is a Radio Frequency (RF) board installed in a main body of a terminal, an antenna carrier 20 installed on the main board 10 and having a predetermined height, an antenna radiator 30 installed on a top surface 21 of the antenna carrier 20, and a conductor 40 installed at the antenna carrier 20 and installed separately from the antenna radiator 30.

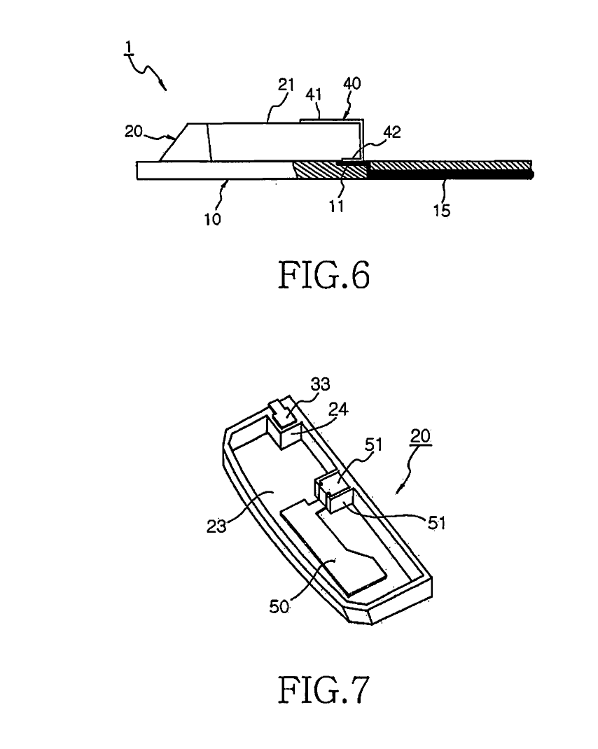

Various electronic function groups (not shown) of the terminal are mounted on the main board 10. Also, the main board 10 includes a feed pad 12 and a ground pad 11 that are electrically connected to the antenna radiator 30 and the conductor 40, respectively. The feed pad 12 is electrically connected to an RF connector 14 installed on the main board 10 by a predetermined pattern 13. Of course, as illustrated in FIG. 6, the ground pad 11 is electrically connected to a conductive layer 15 serving as a ground layer.

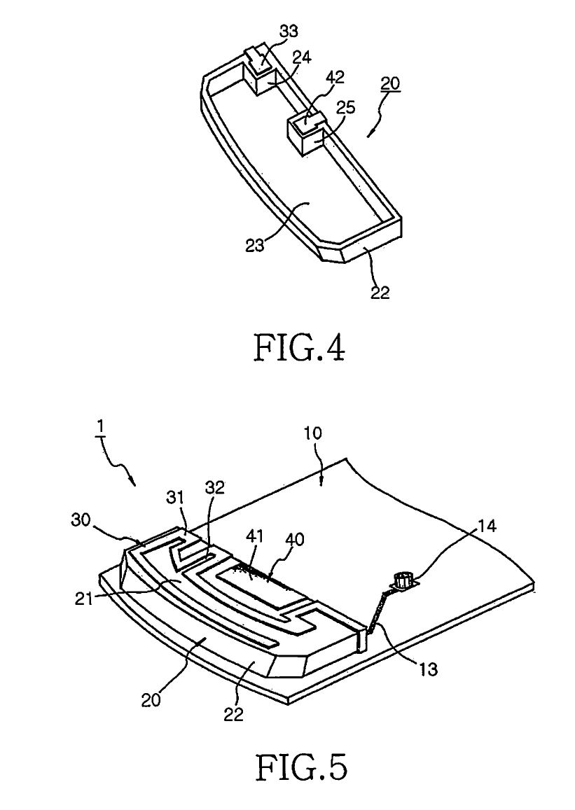

The antenna carrier 20 may be a dielectric body, and may be formed of, for example, a synthetic resin by insert molding. The antenna carrier 20 includes the top surface 21 having a predetermined area, and a side surface 22 extending downwardly from an entire or partial edge of the top surface 21 to a predetermined length. The side surface may extend perpendicularly or may extend, inclined at a predetermined angle, and this may vary depending on a terminal design. The extension length of the side surface 22 may define a height of the antenna carrier 20. Of course, the antenna carrier 20 has a predetermined space therein, and has a bottom surface (23 of FIG. 4) opposite to the top surface 21. Although not shown, the antenna carrier 20 may be fixed to the main board 10 by a snap-fit structure.

The antenna radiator 30 is a plate type metal body, and includes a pattern portion 31 fixed on the top surface 21 of the antenna carrier 20 by a predetermined slot 32, and a feed point 33 extending from the pattern portion 31 toward the bottom surface of the antenna carrier 20 via the side surface 22 thereof For the application of the conductor 40 according to the present invention, the antenna radiator 30 may be a monopole type. The antenna radiator 30 may be a Planar Inverted-L Antenna (PILA) radiator.

The conductor 40 is installed separately from the antenna radiator 30, and may be formed of one of various conductive materials. For example, the conductor 40 may be a plate type metal body, and a planar portion 41 of the conductor 40 is fixed on the top surface 21 of the antenna carrier 20, and a part of the planar portion 41 may extend from the side surface 22 of the antenna carrier 20 toward the bottom surface thereof so as to serve as a ground point 42. The ground point 42 of the conductor 40 is electrically connected to the ground pad 11 of the main board 10.

Although the conductor 40 is formed of a plate type metal in FIG. 3, the present invention is not limited thereto. For example, a Flexible Printed Circuit Board (FPCB) including a pattern with a predetermined width may be used as the conductor 40. A conductive pigment may be applied on a predetermined location of the antenna carrier 20 to have a predetermined area and height. Also, the antenna radiator 30 and the conductor 40 may be firmly fixed to the antenna carrier 20 by a well-know fixing method such as bonding, and ultrasonic welding.

FIG. 4 is a rear perspective view of the antenna carrier to which the antenna radiator according to the present invention is mounted, and FIG. 5 is an assembled perspective view of the antenna according to the present invention.

Referring to FIGS. 4 and 5, the feed point 33 extending from the antenna radiator 30, and the ground point 42 extending from the conductor 40 are respectively supported by bushings 24 and 25 extending upwardly from the bottom surface 23 of the antenna carrier 20. Thus, when the antenna carrier 20 is mounted to the main board 10, the feed point 33 of the antenna radiator 30 contacts the feed pad 12 connected to the RF connector 14 of the main board 10, and thus is electrically connected to the RF connector 14. The ground point 42 of the conductor 40 contacts the ground pad 11 connected to the ground layer (i.e., conductive layer) of the main board 10, and thus is electrically connected to the ground layer of the main board 10. Consequently, the conductor 40 is electrically connected to the ground layer, thereby increasing a ground area.

FIG. 6 is a cross-sectional view of a main part, illustrating a ground structure of the conductor of the antenna according to the present invention, and a power feeding relation between the antenna radiator and the feed pad of the main board is omitted in the drawing.

As illustrated in FIG. 6, when the antenna carrier 20 is mounted on the main board 10, the ground point 42 of the conductor 40 installed under the antenna carrier 20 contacts the ground pad 11 formed on the main board 10. Since the ground pad 11 is electrically connected to the ground layer 15 formed in the main board 10 with a predetermined area, the conductor 40 is electrically connected to the ground layer 15, thereby increasing the ground area.

Although the ground layer 15 is not formed at a region of the main board 10 where the antenna carrier 20 is installed in FIG. 6, the ground layer 15 may extend up to a bottom side the antenna carrier 20 in order to achieve an efficient radiation characteristic of the antenna radiator 30.

FIG. 7 is a rear perspective view of the antenna carrier, illustrating that a conductor is installed at a different location of the antenna carrier from that of FIG. 3. A conductor 50 may be fixed to the bottom surface 23 in an internal space of the antenna carrier 20. To improve a radiation characteristic of the antenna radiator 30, the conductor 50 may be installed on the bottom surface 23 of the antenna carrier 20, which does not overlap a region in which the antenna radiator 30 is installed. However, the conductor 50 may overlap the region in which the antenna radiator 30 is installed.

Although not shown, the conductor 50 may be installed or formed with a predetermined area at a predetermined portion of the side surface of the antenna carrier 20. If the conductor 50 is a thin plate type metal body and the antenna carrier 20 is formed of a synthetic resin material, the conductor 50 may be interposed in a predetermined portion inside the antenna carrier 20 by a method such as insert molding when the antenna carrier 20 is insert-molded. In this case, a pattern design of the antenna radiator 30 is not affected by a limitation of a conductor installation portion on the antenna carrier 20.

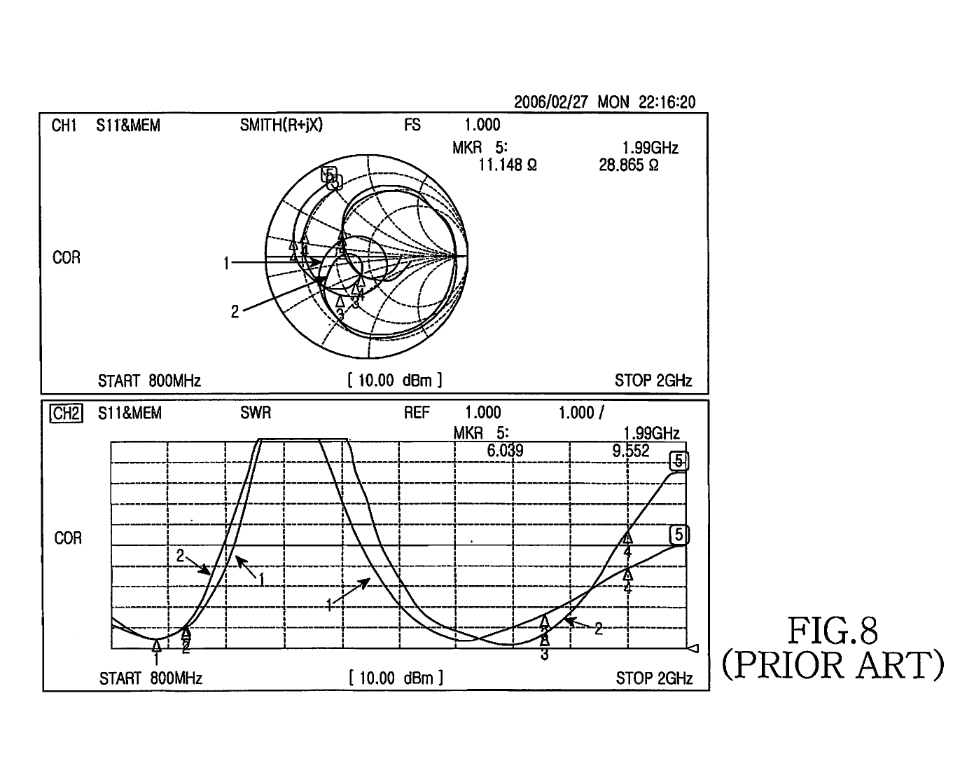

FIG. 8 illustrates a Smith chart and a VSWR graph, showing states before and after a finger-touch on a terminal including a conventional antenna radiator.

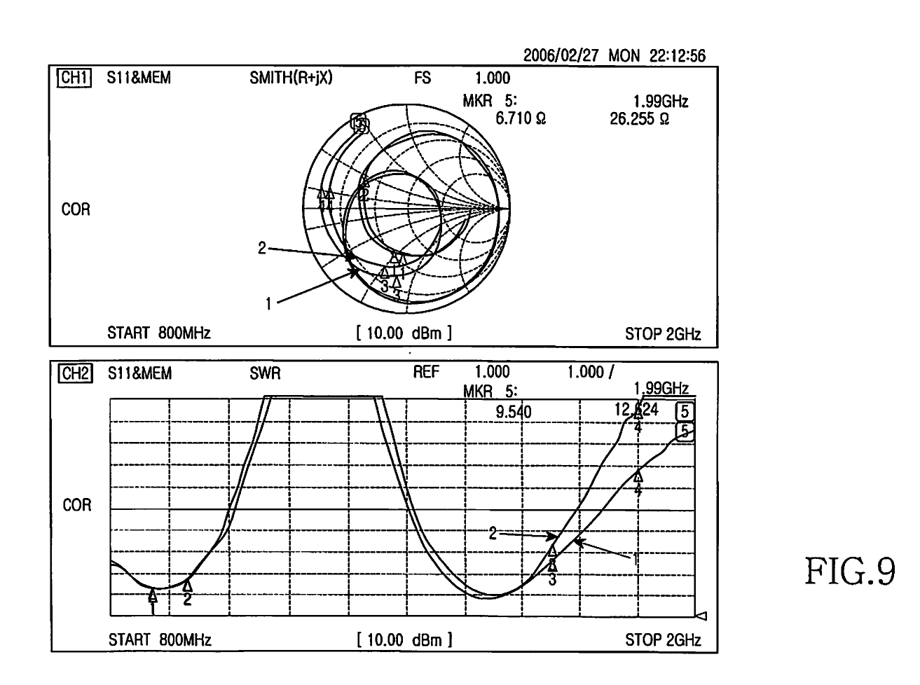

FIG. 9 illustrates a smith and a VSWR graph, showing states before and after a finger-touch on a terminal including an antenna radiator according to the present invention.

In FIGS. 8 and 9, the reference number 1 indicates a radiation pattern and a VSWR in the case where a terminal is in a free-space state, and the reference number 2 indicates a radiation pattern and a VSWR in the case where a terminal is grasped and used, that is, in a talk state.

In the Smith chart and the VSWR graph of FIG. 8, although the bandwidth greatly increases in the free-space state and the talk state, fluctuation of a radiation characteristic occurs quite severely.

In contrast, in the Smith chart and the VSWR graph of FIG. 9, almost no increase in bandwidth occurs, but the fluctuation in radiation characteristic is relatively small before and after the finger-touch on the terminal. Thus, It can be seen that when the conductor according to the present invention is used, a smooth call may be achieved without a change in radiation characteristic, which means that call disconnection such as a mute phenomenon is prevented from occurring.

In the built-in antenna according to the present invention, the conductor is provided separately from the antenna radiator on the antenna carrier, thereby expanding a ground area. Thus, the radiation-characteristic fluctuation caused by external interference of the terminal can be remarkably reduced, thereby improving call quality of the terminal.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A built-in antenna for a portable terminal, comprising:
a main board including a feed pad electrically connected to a Radio Frequency (RF) connector, and a ground layer;
an antenna carrier installed on the main board and having a predetermined height;
an antenna radiator installed at the antenna carrier and having a predetermined shape, the antenna radiator being electrically connected to the feed 10 pad; and
a conductor installed at a predetermined portion of the antenna carrier the conductor being electrically connected to the ground layer.

2. The built-in antenna of claim 1, wherein the antenna radiator and the conductor are separately installed.

3. The built-in antenna of claim 2, wherein the antenna radiator is a Planar Inverted-L Antenna (PILA) radiator electrically connected only to the feed pad.

4. The built-in antenna of claim 1, wherein the antenna carrier comprises:
a top surface having a predetermined area;
a side surface extending downwardly from an entire or partial edge of the top surface to a predetermined length, the side surface defining a height of the antenna carrier; and
a bottom surface opposite to the top surface, the bottom surface having an internal space,
wherein the top surface, the side surface, and the bottom surface are integrally formed, and the antenna radiator is installed on the top surface of the antenna carrier.

5. The built-in antenna of claim 4, wherein the conductor is installed at a predetermined portion of the top surface of the antenna carrier.

6. The built-in antenna of claim 4, wherein the conductor is installed at a predetermined portion of the side surface of the antenna carrier.

7. The built-in antenna of claim 4, wherein the conductor is installed at a predetermined portion of the bottom surface of the antenna carrier.

8. The built-in antenna of claim 4, wherein the antenna radiator and the conductor are bonded on the antenna carrier.

9. The built-in antenna of claim 5, wherein the antenna radiator and the conductor are bonded on the antenna carrier.

10. The built-in antenna of claim 6, wherein the antenna radiator and the conductor are bonded on the antenna carrier.

11. The built-in antenna of claim 7, wherein the antenna radiator and the conductor are bonded on the antenna carrier.

12. The built-in antenna of claim 4, wherein the antenna radiator and the conductor are fixed on the antenna carrier by ultrasonic-welding.

13. The built-in antenna of claim 5, wherein the antenna radiator and the conductor are fixed on the antenna carrier by ultrasonic-welding.

14. The built-in antenna of claim 6, wherein the antenna radiator and the conductor are fixed on the antenna carrier by ultrasonic-welding.

15. The built-in antenna of claim 7, wherein the antenna radiator and the conductor are fixed on the antenna carrier by ultrasonic-welding.

16. The built-in antenna of claim 1, wherein the conductor is a plate type metal body.

17. The built-in antenna of claim 16, wherein the antenna carrier is formed of a synthetic resin, and the plate type metal body is insert-molded at a predetermined location of the antenna carrier.

18. The built-in antenna of claim 1, wherein the conductor is a Flexible Printed Circuit Board (FPCB) including a plate type pattern with a predetermined width.

19. The built-in antenna of claim 1, wherein the conductor is a conductive pigment applied on the antenna carrier to have a predetermined area and width, separated from the antenna radiator.
